(19) United States
(12) Patent Application Publication
(10) Pub. No.: US 2015/0008737 A1
(43) Pub. Date: Jan. 8, 2015

(54) Off-grid/grid-connected integrated solar power generation system and control method thereof

(71) Applicant: Jiansheng Mao, Wuxi (CN)

(72) Inventor: Jiansheng Mao, Wuxi (CN)

(73) Assignee: ZHENFA ENERGY GROUP CO., LTD., Yubei District Chongqing (CN)

(21) Appl. No.: 14/379,299

(22) PCT Filed: Mar. 5, 2012
(86) PCT No.: PCT/CN2012/071953

§ 371 Date: Aug. 17, 2014

(30) Foreign Application Priority Data
Feb. 17, 2012 (CN) 201210036474.2

(51) Int. Cl. H02J 5/00; H02J 7/35; H02J 7/00

(52) U.S. Cl. CPC H02J 5/00; H02J 7/0013; H02J 7/007; H02J 7/35
USPC 307/22

(57) ABSTRACT

A control method of an off-grid/grid-connected integrated solar power generation system includes steps of: selecting an off-grid mode or a grid-connected mode by a system operation mode controller, and controlling work states of an electrical input orientation driver, a generation and storage driver, and an electrical output orientation driver by a logical control unit according to feedback of a solar panel, an inverter, a storage battery charging controller, and a storage battery matrix, in such a manner that the off-grid/grid-connected integrated solar power generation system circularly repeats storage and output of solar electrical power in the off-grid mode or the grid-connected mode. An off-grid/grid-connected integrated solar power generation system is also provided. The system and the method are able to meet user requirements of off-grid and grid-connected generation of a solar power generation system, and are able to store and copy peak power of an external power grid.

### CROSS REFERENCE OF RELATED APPLICATION

This is a U.S. National Stage under 35 U.S.C. 371 of the International Application PCT/CN2012/071953, filed Mar. 5, 2012, which claims priority under 35 U.S.C. 119(a-d) to CN 201210036474.2, filed Feb. 17, 2012.

### BACKGROUND OF THE PRESENT INVENTION

1. Field of Invention

The present invention relates to a technical field of solar power generation, and more particularly to an off-grid/grid-connected integrated solar power generation system and a control method thereof.

2. Description of Related Arts

The conventional solar power generation systems are classified into the off-grid solar power generation system and the grid-connected solar power generation system. In the conventional off-grid solar power generation system, an electricity storage circuit 8 and a power circuit 9 are arranged in a reversed it form (see FIG. 1); a solar panel 1 converts solar energy into electrical energy before charging a storage battery 5 through a direct solar charger 6. The electrical energy stored in the storage battery 5 is converted from a direct current into an alternating current by an inverter 6 for supplying users. Disadvantages are as follows. The structural function is single, and can only supply an individual user with a single mode. Utilization rates of the solar electrical power and the hardware resources are low, which cannot satisfy the users who require multi-functions of the solar power generation system and an emergency supplement of emergency back-up energy. It is even harder to accomplish a supplement of local power grid with power shortage as well as a supplemental support during a valley period of the local power grid. In addition, the conventional off-grid solar power generation system is controlled by an expensive PLC system 7, which is high in cost. And the conventional grid-connected solar power generation system only inversely inputs electrical energy converted by the solar panel into the power grid, instead of directly supplying the user, not to mention lacking generation function without sun light.

### SUMMARY OF THE PRESENT INVENTION

An object of the present invention is to provide an off-grid/grid-connected integrated solar power generation system, which meets requirements of users that a solar power generation system is able to store and copy peak power of an external power grid beside having off-grid and grid-connected generation ability, and that the solar power generation system is able to supply local power grid while the users are well supplied, so as to greatly improve a utilization rate of the solar power generation system and a sharing rate of hardware and software system resources, optimize a system hardware structure, and lower system control and operation costs. In addition, a control method of the off-grid/grid-connected integrated solar power generation system is also provided.

Accordingly, in order to accomplish the above objects, the present invention provides an off-grid/grid-connected integrated solar power generation system, comprising:

a control system;

a solar panel;

an inverter;

a storage battery matrix; and

a storage battery charging controller, wherein the storage battery charging controller is connected to the storage battery matrix;

wherein the control system operates the off-grid/grid-connected integrated solar power generation system in either an off-grid mode or a grid-connected mode.

Preferably, the control system comprises:

a logical control unit;

a system operation mode controller;

an electrical input orientation driver;

a generation and storage driver; and

an electrical output orientation driver;

wherein the system operation mode controller is connected to and controls the electrical input orientation driver, the generation and storage driver, and the electrical output orientation driver through the logical control unit; the solar panel, the inverter, the storage battery charging controller, and the storage battery matrix are connected to and logically controlled by the logical control unit; the solar panel is connected to an input terminal of the inverter through the electrical input orientation driver; an output terminal of the inverter is respectively connected to an input terminal of the electrical output orientation driver and an input terminal of the storage battery charging controller through the generation and storage driver; an output terminal of the electrical output orientation driver is connected to an external power grid in the off-grid mode or the grid-connected mode; a discharge terminal of the storage battery matrix is connected to the electrical input orientation driver.

Preferably, the solar panel, the electrical input orientation driver, the inverter, the generation and storage driver, the storage battery charging controller, and the storage battery matrix form a solar electrical power storage circuit; the storage battery matrix, the electrical input orientation driver, the inverter, the generation and storage driver, and the electrical output orientation driver form a solar electrical power storage and generation circuit; the solar panel, the electrical input orientation driver, the inverter, the generation and storage driver, and the electrical output orientation driver form a solar power generation circuit; the solar electrical power storage circuit, the solar electrical power storage and generation circuit, and the solar power generation circuit form a crossing loop circuit.

Preferably, the electrical input orientation driver controls a direction of an input current of the inverter; the electrical input orientation driver comprises a solar panel electrical output orientation driver and a storage battery matrix electrical output orientation driver connected to each other in series, for respectively controlling inputting electrical power of the solar panel and the storage battery matrix into the inverter; a connection point of the solar panel electrical output orientation driver and the storage battery matrix electrical output orientation driver is connected to the input terminal of the inverter; the generation and storage driver controls a direction of an output current of the inverter when the inverter outputs an inverted power; the generation and storage driver comprises a generation driver and a storage driver connected to each other in series, wherein an input terminal of the generation driver is connected to the output terminal of the inverter, and an output terminal of the storage driver is connected to the input terminal of the storage battery charging controller; a connection point of the generation driver and the storage driver is connected to the input terminal of the electrical output orientation driver; the electrical output orientation driver changes the inverted output current of the inverter between an off-grid direction and a grid-connected direction; and, the electrical output orientation driver comprises a grid-connected output driver and an off-grid output driver connected to each other in parallel.

Preferably, in the grid-connected mode, the control system inputs electrical power from the external power grid into the off-grid/grid-connected integrated solar power generation system, so as to store and copy an electrical resource in the storage battery matrix for charging and storing; the grid-connected output driver, the storage driver, the storage battery charging controller, and the storage battery matrix are connected for forming a circuit which stores power from the external power grid in storage batteries of the storage battery matrix.

Preferably, the inverter has a max power point track (MPPT in short) function; the inverter has an off-grid active mode and a grid-connected passive mode; in the off-grid active mode, the inverter shields port data detection and outputs the inverted power with preset parameters comprising voltage and frequency; in the grid-connected passive mode, the inverter automatically detects a port voltage data characteristic of the external power grid, and passively outputs the inverted power according to the detected port voltage data characteristic, such as adapting phase and frequency to operation and avoiding islanding. The system operation mode controller comprises:

a box (cabinet) panel mode controller;

a portable mode selector; and

a remote two-way communication control port;

wherein the box (cabinet) panel mode controller, the portable mode selector, and the remote two-way communication control port are respectively connected to and controls the logical control unit; the box (cabinet) panel mode controller, the portable mode selector, the remote two-way communication control port, and the logical control unit all utilize digital logic chips and micro control units (MCU for short). The storage battery charging controller has an alternating input; an isolation mechanism is provided at an output terminal of the storage battery charging controller for preventing an inverse current from the storage battery.

A control method of the off-grid/grid-connected integrated solar power generation system is also provided, comprising steps of:

selecting an off-grid mode or a grid-connected mode by a system operation mode controller, and controlling work states of an electrical input orientation driver, a generation and storage driver, and an electrical output orientation driver by a logical control unit according to feedback about electrical power loads of a solar panel, an inverter, a storage battery charging controller, and a storage battery matrix, in such a manner that the off-grid/grid-connected integrated solar power generation system circularly repeats charging, storing, generating and outputting of solar electrical power in the off-grid mode or the grid-connected mode.

Preferably, in the off-grid mode, the storage battery matrix is charged only when solar electrical power is enough for supplying users; in the off-grid mode, charging, storing, generating and outputting of the solar electrical power is circulated as follows: after the off-grid mode is selected by the system operation mode controller, the logical control unit operates the inverter in an off-grid active mode, and connects the electrical output orientation driver to the inverter; in the meantime, the logical control unit controls the electrical output orientation driver to provide off-grid output drive. When an output voltage of the solar panel meets requirements of charging, storing, generating and outputting, which means the solar electrical power outputted is well enough, under a control of the logical control unit, the electrical input orientation driver is connected to an output terminal of the solar panel; a generation driver is connected to the electrical output orientation driver; and a storage driver is disconnected from the storage battery charging controller, in such a manner that a solar power generation circuit is switched on, so as to provide an off-grid solar power generation. When the output voltage of the solar panel fails to meet the requirements of charging, storing, generating and outputting, which means the solar electrical power is not enough, under the control of the logical control unit, the electrical input orientation driver is disconnected from the solar panel and connected to a discharge terminal of the storage battery matrix for switching on a solar electrical power storage and generation circuit, so as to provide an off-grid storage battery matrix output. When the logical control unit detects that the solar electrical power outputted satisfies requirements of the users, the logical control unit controls the generation and storage driver to connect the storage battery charging controller for switching on a solar electrical power storage circuit, so as to store extra solar electrical power into the storage battery matrix by the storage battery charging controller and provide storage operation of the solar electrical power.

Preferably, in the grid-connected mode, the solar electrical power is for direct grid-connected generation only when the storage battery matrix is fully loaded or a sample current of storage batteries is zero, at the moment, the storage battery is in a default emergency state; in the grid-connected mode, a circulation of charging, storing, generating and outputting of the solar electrical power is: after the grid-connected mode is selected by the system operation mode controller, the logical control unit operates the inverter in a grid-connected passive mode; the inverter automatically detects a port voltage data characteristic of an external power grid, and adapts phase as well as frequency to operation, avoids islanding, etc., for passively outputting according to the port voltage data characteristic. In the grid-connected mode, when the output voltage of the solar panel meets requirements of charging, storing, generating and outputting, which means the solar electrical power outputted is well enough, under control of the logical control unit, the electrical input orientation driver is connected to the solar panel; the storage driver is connected to the storage battery charging controller; the electrical input orientation driver is disconnected from the discharge terminal of the storage battery; and the electrical output orientation driver is disconnected from the external power grid, for switching on the solar electrical power storage circuit, in such a manner to store the solar electrical power in the storage battery matrix; when the storage battery matrix is fully loaded, the logical control unit controls the storage driver to be disconnected from the storage battery charging controller and controls the generation driver to be connected to a grid-connected output driver for switching on the solar power generation circuit, in such a manner to provide direct grid-connected solar power generation; when the output voltage of the solar panel doesn't meet the requirements of charging, storing, generating and outputting, which means the solar electrical power is not enough, under control of the logical control unit, the electrical input orientation driver is disconnected from the solar panel and connected to the discharge terminal of the storage battery matrix, and the logical control unit controls the storage driver to be disconnected from the storage battery charging controller and controls the electrical output orientation driver to be connected to a grid-connected port for switching on the solar electrical power storage and generation circuit, in such a manner to provide grid-connected solar power generation by the storage battery matrix; when the logical control unit detects a requirement of storing power from the external power grid in the storage battery, the logical control unit controls the electrical output orientation driver to provide grid-connected output drive, the generation driver is disconnected from the inverter, and the output terminal of the storage battery matrix is disconnected from the electrical input orientation driver, at the meantime, the logical control unit controls the storage driver to be connected to the storage battery charging controller for switching on an inverse input storage circuit of the storage battery for storing the power from the external power grid, in such a manner to charge the storage battery matrix with the power of the external power grid.

According to the present invention, advantages of the off-grid/grid-connected integrated solar power generation system are as follows. The control system is able to switch between the off-grid mode and the grid-connected mode according to actual requirements of the users. Not only is stability of the external network improved, but also utilization efficiency of the power grid is increased. At the same time, the extra solar electrical power is outputted in the grid-connected mode while the users are satisfied, so as to improve the utilization rate of the solar power generation system and meet user requirements of multi-function of the solar power generation system.

According to the present invention, other advantages of the off-grid/grid-connected integrated solar power generation system are as follows. Firstly, the storage battery charging controller is connected to the output terminal of the inverter according to a system design. With the foregoing structure, the electrical power resources of the solar electrical power storage circuit, the solar electrical power storage and generation circuit, and the solar power generation circuit travel through the system in a crossing loop form, which provides the following advantages: 1) the inverter is in both the solar electrical power storage circuit and the solar power generation circuit, in such a manner that hardware and software resources of the inverter with the effective maximum power point tracking (MPPT in short) function are shared for many times; 2) the storage battery charging controller is in both the solar electrical power storage circuit and the circuit of the external power grid for charging the storage battery matrix, in such a manner that hardware and software resources of the storage battery charging controller are also shared for many times; the requirement that the solar electrical power charges and is stored in the storage battery is satisfied, as well as the user requirement that the external power is inversely inputted into the storage battery matrix; the system is able to store and copy peak power of the local external power grid, in such a manner that the storage battery matrix is a backup of a local power grid for emergency utilization and supplying the local power grid with power shortage; 3) because the storage battery charging controller is designed to be placed at the output terminal of the inverter, when the system is in the storage battery matrix default state such as the storage battery matrix is removed by the user for external emergency power supply, the solar panel still outputs enough power and the system is still able to provide off-grid or grid-connected solar power generation, which effectively improves the emergency control ability of the system, and further satisfies the user requirements of multi-function of the solar power generation system.

Secondly, the system adopts a modularized structure design. By building and flexibly applying the electrical input orientation driver, the generation and storage driver, and the electrical output orientation driver which control directions of the power resources, objects of the operation modes and multi-functional application of the off-grid/grid-connected integrated solar power generation system are archived based on the basic parts of the conventional solar power generation system.

Moreover, during interface design of the system, referring to a human-machine interface, an overall design concept of systematic engineering is utilized, which is specifically reflected in designs and application of modules with systematized functions, componentized structures, as well as integrated human-machine systems, and in an independent system operation under control of three modes. First, the system is able to work under a mode given by a conventional manual box (cabinet) panel. Second, the system is able to work under management of a conventional portable mode selector. Third, the system is able to work under an informational control mode through a remote two-way communication control port. According to designs and construction of the present invention, power resource directions in the crossing loop form, a modularized function structure design and even systemized network information mode of management level ensure that the system is able to not only meet the user requirements of multi-functional application of the solar power generation system, but also supply the external local power grid with power shortage as long as the users are well supplied, which greatly improves the utilization rate of solar power generation system and the sharing rate of the hardware and the software resources, optimizes the system structure, reduces costs of system control and operation, and increases price performance of the system, in such a manner that the system is more valuable in the market.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a reversed π operation structure of a conventional off-grid solar power generation system.

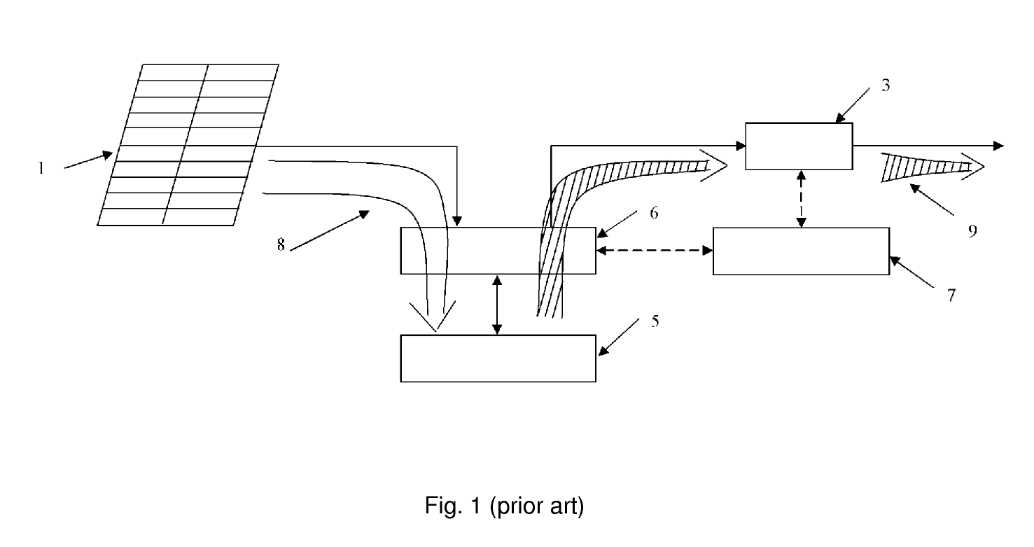

FIG. 2 is a schematic view of a system structure of an off-grid/grid-connected integrated solar power generation system according to a preferred embodiment of the present invention.

FIG. 3 is a sketch view of a control method of the off-grid/grid-connected integrated solar power generation system according to the preferred embodiment of the present invention.

FIG. 4 is a schematic view of an electrical control structure of the off-grid/grid-connected integrated solar power generation system according to the preferred embodiment of the present invention.

FIG. 5 is a schematic view of a crossing loop storage and generation operation structure of the off-grid/grid-connected integrated solar power generation system according to the preferred embodiment of the present invention.

FIG. 6 is a schematic view of a solar electrical power storage circuit of the off-grid/grid-connected integrated solar power generation system according to the preferred embodiment of the present invention.

FIG. 7 is a schematic view of a grid-connected generation circuit utilizing stored power of the off-grid/grid-connected integrated solar power generation system according to the preferred embodiment of the present invention.

FIG. 8 is a schematic view of a direct grid-connected generation circuit utilizing solar electrical power of the off-grid/grid-connected integrated solar power generation system according to the preferred embodiment of the present invention.

FIG. 9 is a schematic view of a storage circuit for charging a storage battery matrix with power of an external power grid of the off-grid/grid-connected integrated solar power generation system according to the preferred embodiment of the present invention.

### DETAILED DESCRIPTION OF THE PREFERRED EMBODIMENT

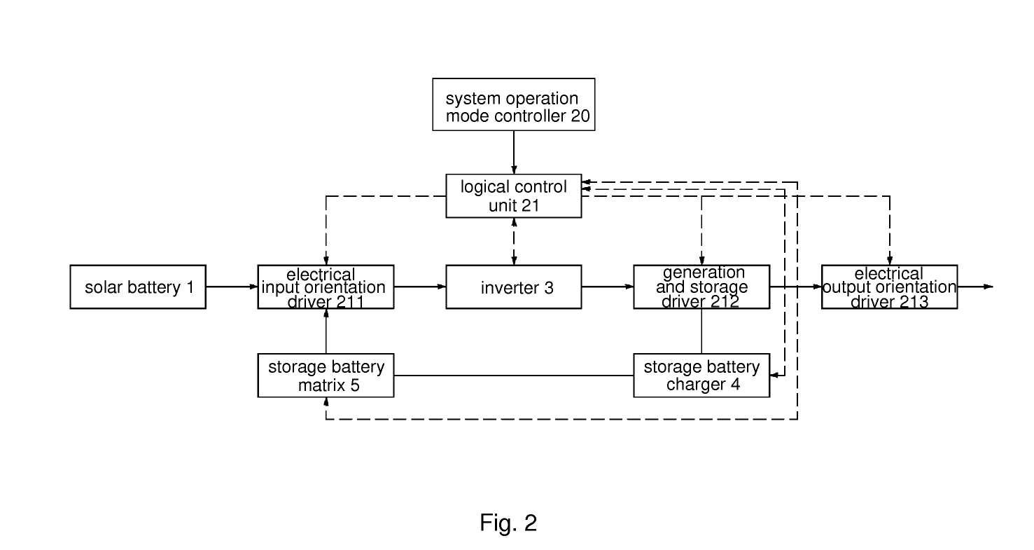

Referring to FIG. 2 of the drawings, an off-grid/grid-connected integrated solar power generation system is illustrated, comprising

a solar panel 1;

an inverter 3;

a storage battery matrix 5;

a storage battery charging controller 4; and

a control system 2;

wherein the storage battery charging controller 4 is connected to the storage battery matrix 5; the control system 2 operates the off-grid/grid-connected integrated solar power generation system in either an off-grid mode or a grid-connected mode. Preferably, the control system 2 comprises:

a logical control unit 21;

a system operation mode controller 20;

an electrical input orientation driver 211;

a generation and storage driver 212; and

an electrical output orientation driver 213;

wherein the system operation mode controller 20 is connected to and controls the electrical input orientation driver 211, the generation and storage driver 212, the electrical output orientation driver 213 through the logical control unit 21; the inverter 3, the storage battery charging controller 4, and the storage battery matrix 5 are connected to and logically controlled by the logical control unit 21; the solar panel 1 is connected to an input terminal of the inverter 3 through the electrical input orientation driver 211; an output terminal of the inverter 3 is respectively connected to an input terminal of the electrical output orientation driver 213 and an input terminal of the storage battery charging controller 4 through the generation and storage driver 212; an output terminal of the electrical output orientation driver 213 is connected to an external power grid in the off-grid mode or the grid-connected mode; a discharge terminal of the storage battery matrix 5 is connected to the electrical input orientation driver 211.

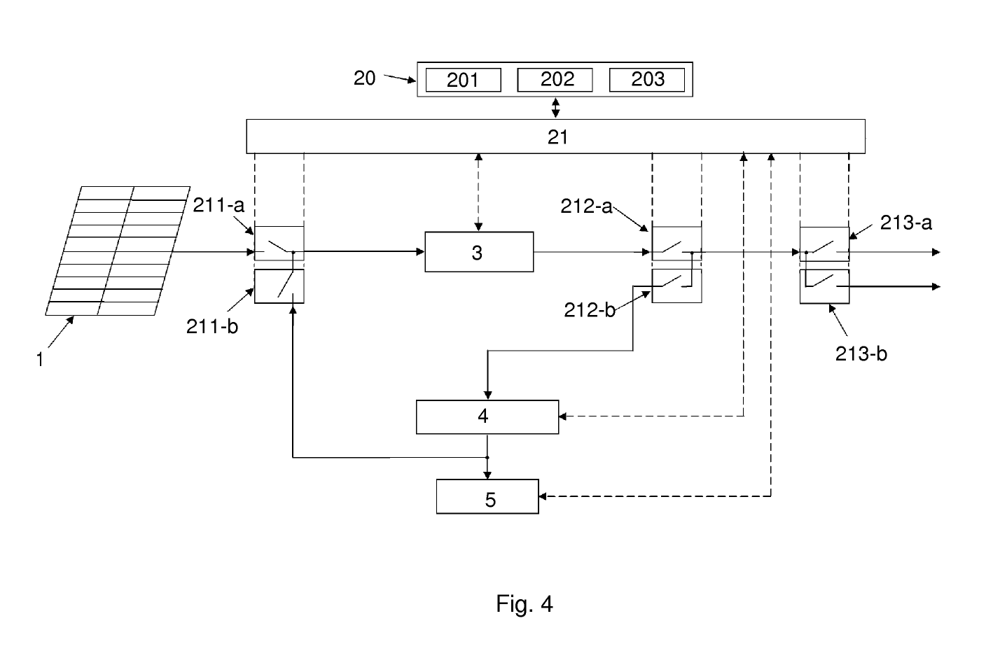

Referring to FIG. 4 of the drawings, the electrical input orientation driver 211 controls a direction of an input current of the inverter 3, the electrical input orientation driver 211 comprises a solar panel electrical output orientation driver 211-a and a storage battery matrix electrical output orientation driver 211-b connected to each other in series, for respectively controlling inputting electrical power of the solar panel 1 and the storage battery matrix 5 into the inverter 3; the solar panel electrical output orientation driver 211-a and the storage battery matrix electrical output orientation driver 211-b of the electrical input orientation driver 211 are controlled according to the logical control unit 21. The generation and storage driver 212 control a direction of an output current of the inverter 3 when the inverter 3 outputs an inverted electrical power; the generation and storage driver 212 comprises a generation driver 212-a and a storage driver 212-b connected to each other in series, wherein an output terminal of the storage driver 212-b is connected to the input terminal of the storage battery charging controller 4; a charging input terminal of the storage driver 212-b is connected to a connection point of the generation driver and the storage driver, as well as the input terminal of the electrical output orientation driver 213. The electrical output orientation driver 213 changes the inverted output current of the inverter 3 between an off-grid direction and a grid-connected direction, and the electrical output orientation driver 213 comprises a grid-connected output driver 213-a and an off-grid output driver 213-b connected to each other in parallel.

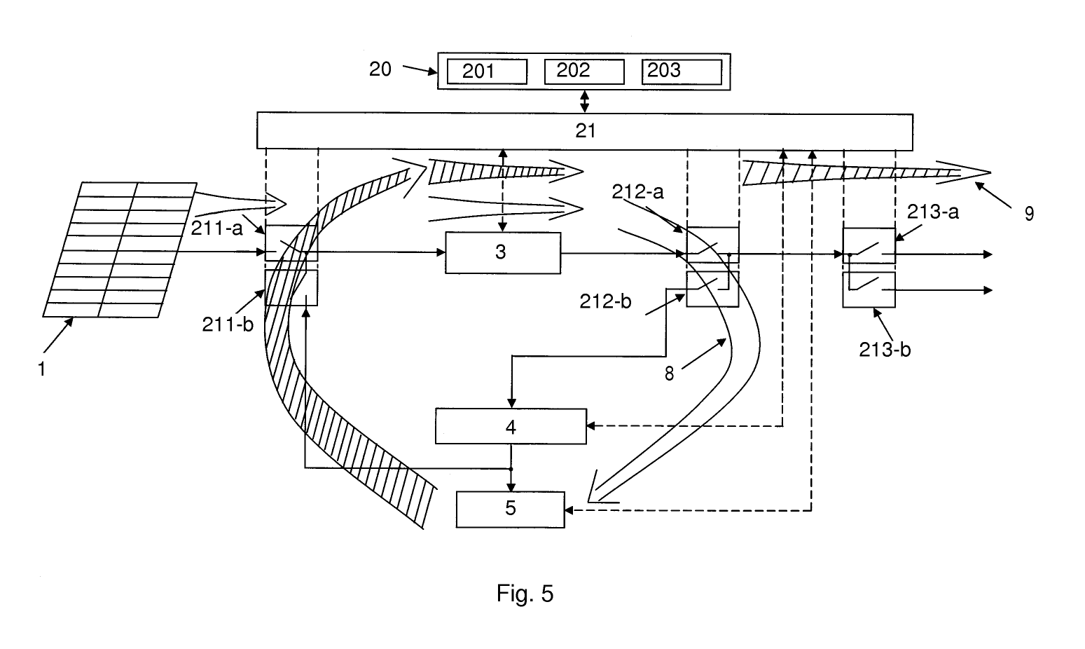

Preferably, the solar panel 1, the solar panel electrical output orientation driver 211-a, the inverter 3, the generation driver 212-a, the storage driver 212-b, the storage battery charging controller 4, and the storage battery matrix 5 form a solar electrical power storage circuit; the storage battery matrix 5, the storage battery matrix electrical output orientation driver 211-b, the inverter 3, the generation driver 212-a, and the electrical output orientation driver 213 form a solar electrical power storage and generation circuit; the solar panel 1, the solar panel electrical output orientation driver 211-a, the inverter 3, the generation driver 212-a, and the electrical output orientation driver 213 form a solar power generation circuit; the solar electrical power storage circuit, the solar electrical power storage and generation circuit, and the solar power generation circuit form a crossing loop circuit (see FIG. 5).

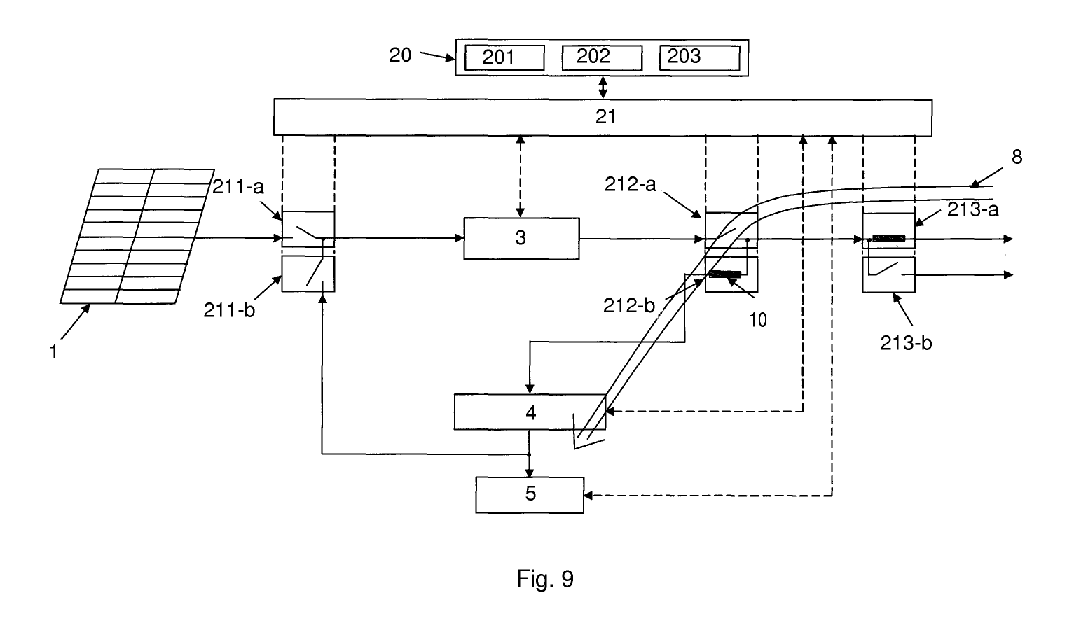

Preferably, in the grid-connected mode, the control system 2 inputs electrical power from the external power grid into, and operates charging and electricity storage on the storage battery matrix 5; the control system 2 is connected to and controls the grid-connected output driver 213-a, the storage driver 212-b and the storage battery charging controller 4 through the logical control unit 21, in such a manner that the storage battery matrix 5 is charged by the external power grid; the grid-connected output driver 213-a, the storage driver 212-b, the storage battery charging controller 4, and the storage battery matrix 5 are connected for forming a storage circuit for charging storage batteries of the storage battery matrix with electricity from an external (see FIG. 9).

Preferably, the inverter 3 has a max power point track (MPPT in short) function; the inverter 3 has an off-grid active mode and a grid-connected passive mode; in the off-grid active mode, the inverter 3 shields port data detection and outputs the inverted power with preset parameters such as voltage and frequency; in the grid-connected passive mode, the inverter 3 automatically detects a port voltage data characteristic of the external power grid, and passively outputs the inverted power according to the detected port voltage data characteristic, such as adapting phase and frequency to operation and avoiding islanding.

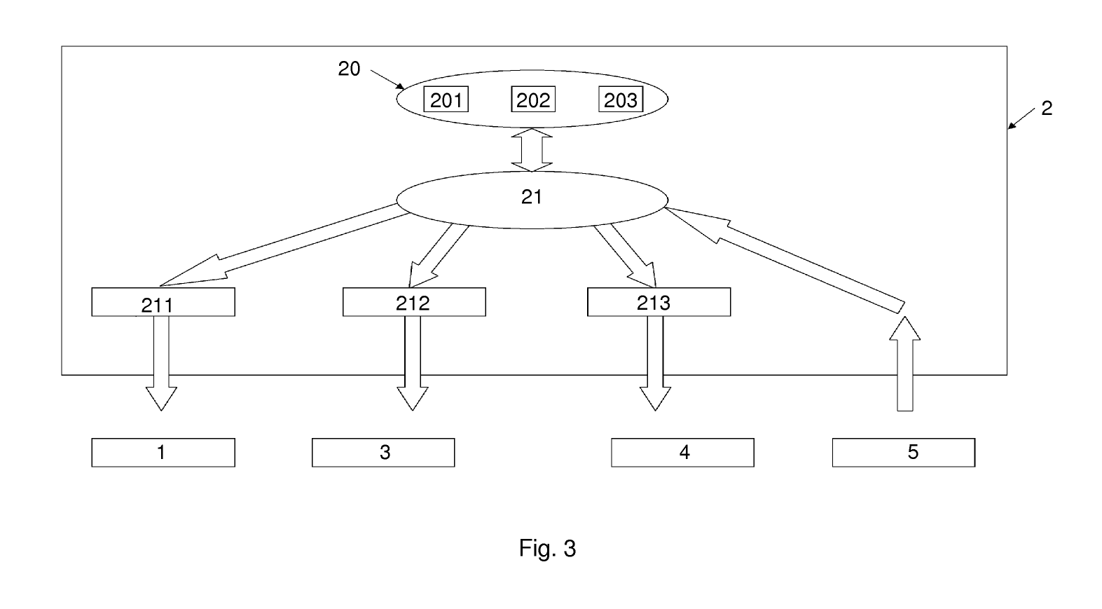

Referring to the FIG. 3 of the drawings, the system operation mode controller 20 comprises:

a box (cabinet) panel mode controller 201;

a portable mode selector 202; and

a remote two-way communication control port 203;

wherein the box (cabinet) panel mode controller 201, the portable mode selector 202, and the remote two-way communication control port 203 are respectively connected to and controls the logical control unit 21; the system operation mode controller 20 and the logical control unit 21 both utilize digital logic chips and micro control units (MCU for short). The box (cabinet) panel mode controller 201, the portable mode selector 202, and the remote two-way communication control port 203 are able to respectively or compatibly control a system operation mode of the logical control unit 21. The storage battery charging controller 4 is has an alternating input; an isolation mechanism is provided at the output terminal of the storage battery charging controller 4 for preventing an inverse current from the storage battery.

A control method of the off-grid/grid-connected integrated solar electrical power generation system is also provided (see FIG. 3), comprising steps of:

selecting an off-grid mode or a grid-connected mode by a system operation mode controller 20, and controlling work states of an electrical input orientation driver 211, a generation and storage driver 212, and an electrical output orientation driver 213 by a logical control unit 21 according to feedback about electrical power loads of a solar panel 1, an inverter 3, a storage battery charging controller 4, and a storage battery matrix 5, in such a manner that the off-grid/grid-connected integrated solar power generation system circularly charges, stores, generates and outputs solar electrical power in the off-grid mode or the grid-connected mode, and stores and copies peak power of an external power grid.

Preferably, in the off-grid mode, the storage battery matrix 5 is charged only when solar electrical power is enough for supplying users; in the off-grid mode, circulation of charging, storing, generating and outputting of the solar electrical power (see FIG. 3 and FIG. 4) is: after the off-grid mode is selected by the system operation mode controller 20, the logical control unit 21 operates the inverter 3 in an off-grid active mode, and connects the electrical output orientation driver 211 to the inverter 3; at the meantime, the logical control unit 21 controls the generation driver 212-a to communicate with the off-grid output driver 213-b. When output voltage of the solar panel meets requirements of charging, storing, generating and outputting, which means the solar electrical power outputted is well enough due to enough sunshine in the daytime, under control of the logical control unit 21, a solar panel electrical output orientation driver 211-a of the electrical input orientation driver 211 is connected to an output terminal of the solar panel 1, and a generation driver 212-a of the generation and storage driver 212 is connected to the off-grid output driver 213-b of the electrical output orientation driver 213 for switching on a solar power generation circuit, in such a manner to provide off-grid solar power generation. When the logical control unit 21 detects that the solar electrical power outputted satisfies requirements of the off-grid users, which means the solar electrical power outputted is well enough, the logical control unit 21 controls the storage driver 212-b of the generation and storage driver 212 to communicate with the storage battery charging controller 4 for switching on a solar electrical power storage circuit, in such a manner to storing extra solar electrical power into the storage battery matrix 5 by the storage battery charging controller 4 and provide storage operation of the solar electrical power. When the output voltage of the solar panel doesn't meet the requirements of charging, storing, generating and outputting, which means the solar electrical power is not enough due to no sunshine in the night or continuous wet days, under control of the logical control unit 21, the solar panel electrical output orientation driver 211-a of the electrical input orientation driver 211 is disconnected from the solar panel 1, and the electrical input orientation driver 211 is connected to a discharge terminal of the storage battery matrix 5 by switching on the storage battery matrix electrical output orientation driver 211-b for switching on a solar electrical power storage and generation circuit, in such a manner to provide off-grid storage battery matrix inverse output.

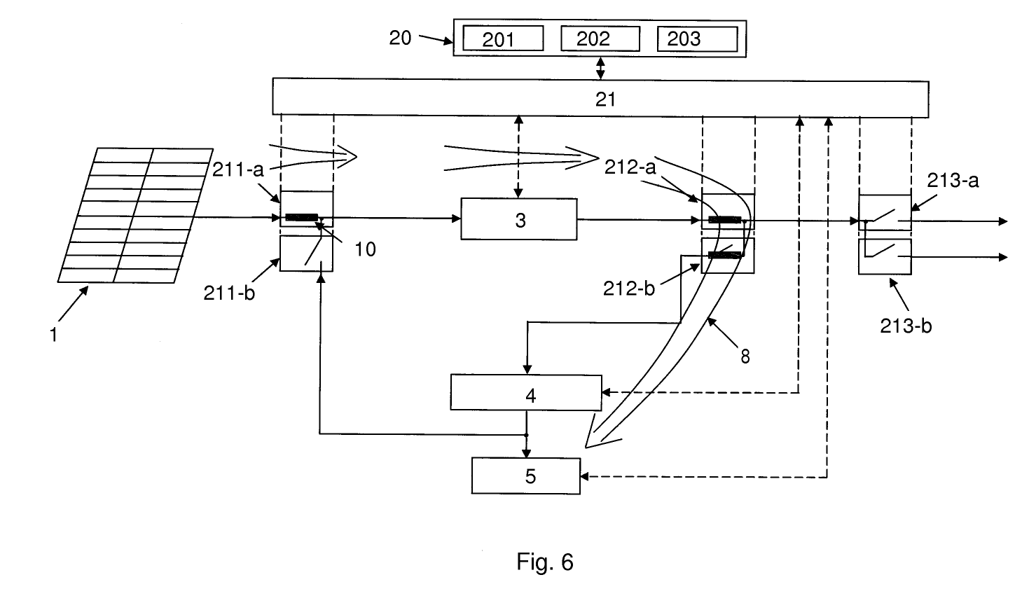

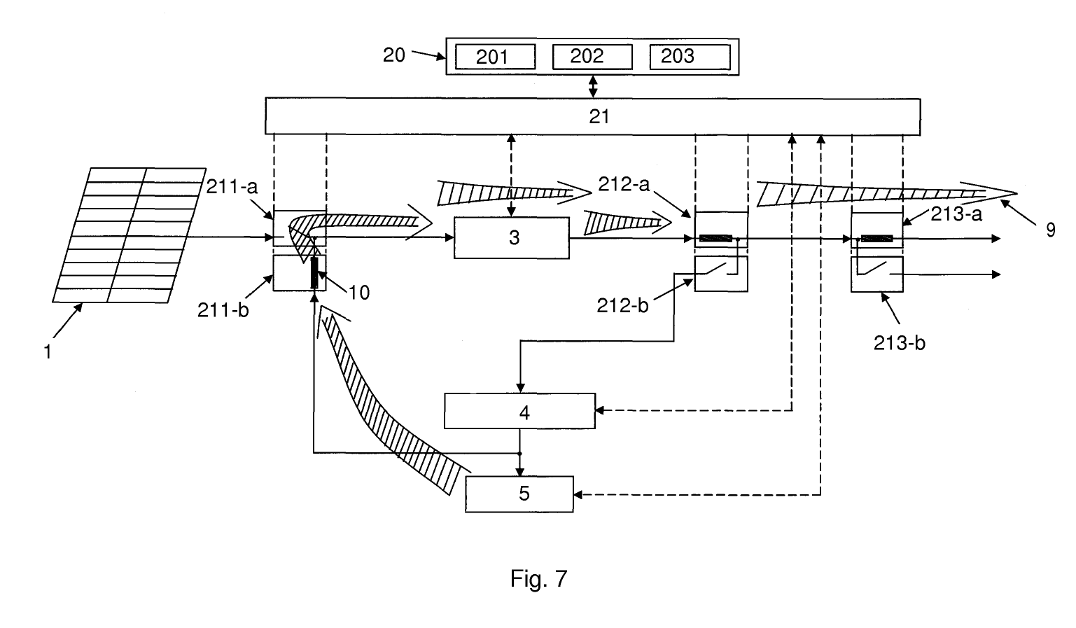

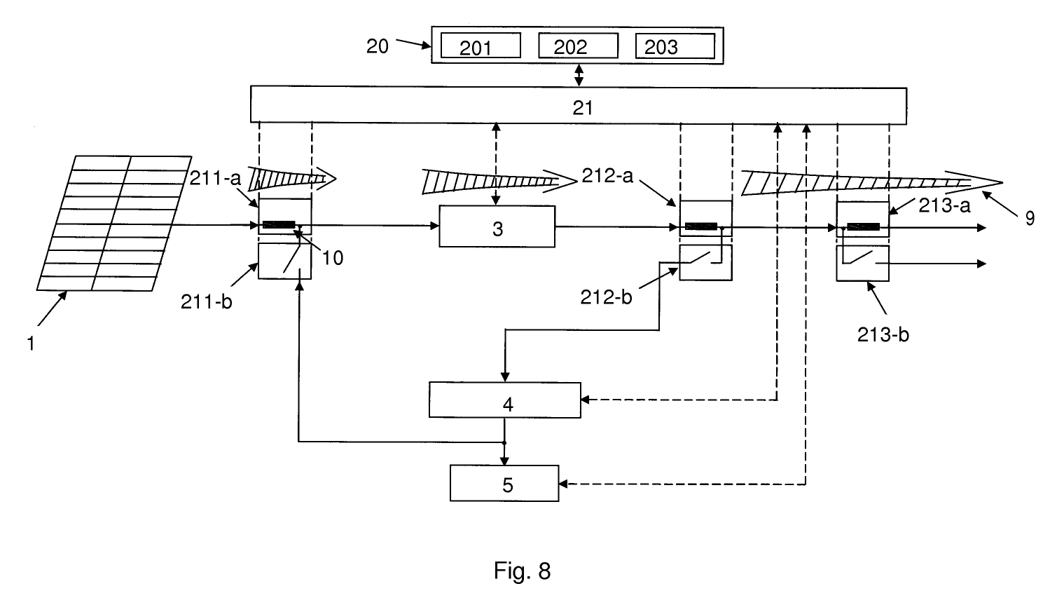

Referring to FIG. 3 and FIG. 4 of the drawings, in the grid-connected mode, the solar electrical power is for direct grid-connected generation only when the storage battery matrix 5 is fully loaded or a sample current of storage batteries is zero, at the moment, the storage battery is in a default emergency state; in the grid-connected mode, circulation of charging, storing, generating and outputting of the solar electrical power is: after the grid-connected mode is selected by the system operation mode controller 20, the logical control unit 21 operates the inverter 3 in a grid-connected passive mode, the inverter 3 automatically detects a port voltage data characteristic of an external power grid, and adapts phase and frequency to operation, avoids islanding, etc., for passively outputting according to the port voltage data characteristic; in the grid-connected mode, when the output voltage of the solar panel 1 meets requirements of charging, storing, generating and outputting, which means the solar electrical power outputted is well enough, under control of the logical control unit 21, the solar panel electrical output orientation driver 211-a of the electrical input orientation driver 211 is connected to the solar panel 1, the storage driver 212-b is connected to the storage battery charging controller 4, and the storage battery matrix electrical output orientation driver 211-b is disconnected from the discharge terminal of the storage battery matrix 5 (by switching off the storage battery matrix electrical output orientation driver 211-b) for switching on the solar electrical power storage circuit, in such a manner to store the solar electrical power in the storage battery matrix 5 (see FIG. 6); when the storage battery matrix 5 is fully loaded, the logical control unit 21 controls the storage driver 212-b of the generation and storage driver 212 to be disconnected from the storage battery charging controller 4 and controls the output grid-connected driver 213-a of the electrical output orientation driver 213 to be connected to a grid-connected port for switching on the solar power generation circuit (see FIG. 8), in such a manner to provide direct grid-connected solar power generation; when the output voltage of the solar panel 1 doesn't meet the requirements of charging, storing, generating and outputting, which means the solar electrical power is not enough or at night, under control of the logical control unit 21, the solar panel electrical output orientation driver 211-a is disconnected from the solar panel 1, and the output terminal of the storage battery matrix 5 is connected to the input terminal of the inverter 3 by switching on the storage battery matrix electrical output orientation driver 211-b, the logical control unit 21 controls the storage driver 212-b of the generation and storage driver 212 to be disconnected from the storage battery charging controller 4 and controls the output grid-connected driver 213-a of the electrical output orientation driver 213 to be connected to the grid-connected port for switching on the solar electrical power storage and grid-connected generation circuit (see FIG. 7), in such a manner to provide grid-connected solar power generation by the power inversed of the storage battery matrix; when the logical control unit 21 detects a requirement of storing power from the external power grid in the storage battery, under control of the logical control unit 21, the output grid-connected driver 213-a of the electrical output orientation driver 213 to be connected to the external power grid, the generation driver 212-a of the generation and storage driver 212 is disconnected from the inverter 3, the output terminal of the storage battery matrix 5 is disconnected from the storage battery matrix electrical output orientation driver 211-b, and the solar panel electrical output orientation driver 211-a is connected to the input terminal of the inverter 3, at the meantime, the logical control unit 21 controls the storage driver 212-b of the generation and storage driver 212 to be connected to the storage battery charging controller 4 for switching on an inverse input storage circuit of the storage battery for connecting the storage battery charging controller 4 to a circuit storing the power from the external power grid in the storage battery, in such a manner to inversely charge the system with the power of the external power grid (see FIG. 9). FIGS. 6-10 illustrate connection states of the drivers.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-11. (canceled)

12. An off-grid/grid-connected integrated solar power generation system, comprising:
a control system;
a solar panel;
an inverter;
a storage battery matrix; and
a storage battery charging controller, wherein said storage battery charging controller is connected to said storage battery matrix;
wherein said control system operates said off-grid/grid-connected integrated solar power generation system in either an off-grid mode or a grid-connected mode.

13. The device, as recited in claim 12, wherein said control system comprises:
a logical control unit;
a system operation mode controller;
an electrical input orientation driver;
a generation and storage driver; and
an electrical output orientation driver;
wherein said system operation mode controller is connected to and controls said electrical input orientation driver, said generation and storage driver, and said electrical output orientation driver through said logical control unit; said solar panel, said inverter, said storage battery charging controller, and said storage battery matrix are connected to and logically controlled by said logical control unit; said solar panel is connected to an input terminal of said inverter through said electrical input orientation driver; an output terminal of said inverter is respectively connected to an input terminal of said electrical output orientation driver and an input terminal of said storage battery charging controller through said generation and storage driver; an output terminal of said electrical output orientation driver is connected to an external power grid in said off-grid mode or said grid-connected mode; a discharge terminal of said storage battery matrix is connected to said electrical input orientation driver.

14. The device, as recited in claim 13, wherein said solar panel, said electrical input orientation driver, said inverter, said generation and storage driver, said storage battery charging controller, and said storage battery matrix form a solar electrical power storage circuit; said storage battery matrix, said electrical input orientation driver, said inverter, said generation and storage driver, and said electrical output orientation driver form a solar electrical power storage and generation circuit; said solar panel, said electrical input orientation driver, said inverter, said generation and storage driver, and said electrical output orientation driver form a solar power generation circuit; said solar electrical power storage circuit, said solar electrical power storage and generation circuit, and said solar power generation circuit form a crossing loop circuit.

15. The device, as recited in claim 14, wherein said electrical input orientation driver controls a direction of an input current of said inverter, said electrical input orientation driver comprises a solar panel electrical output orientation driver and a storage battery matrix electrical output orientation driver connected to each other in series, for respectively input electrical power of said solar panel and said storage battery matrix into said inverter; a connection point of said solar panel electrical output orientation driver and said storage battery matrix electrical output orientation driver is connected to said input terminal of said inverter; said generation and storage driver control a direction of an output current of said inverter when said inverter outputs an inverted power; said generation and storage driver comprises a generation driver and a storage driver connected to each other in series, wherein an input terminal of said generation driver is connected to said output terminal of said inverter, and an output terminal of said storage driver is connected to said input terminal of said storage battery charging controller, a connection point of said generation driver and said storage driver is connected to said input terminal of said electrical output orientation driver; said electrical output orientation driver changes said output current of said inverter between an off-grid direction and a grid-connected direction, and said electrical output orientation driver comprises a grid-connected output driver and an off-grid output driver connected to each other in parallel.

16. The device, as recited in claim 15, wherein in said grid-connected mode, said control system inputs electrical power from the external power grid into said off-grid/grid-connected integrated solar power generation system, in such a manner to store and copy an electrical resource in said storage battery matrix for charging and storing; said grid-connected output driver, said storage driver, said storage battery charging controller, and said storage battery matrix are connected for forming a circuit which stores power from the external power grid in storage batteries of said storage battery matrix.

17. The device, as recited in claim 15, wherein said inverter has a max power point track (MPPT in short) function; said inverter has an off-grid active mode and a grid-connected passive mode; in said off-grid active mode, said inverter shields port data detection and outputs said inverted power with preset voltage and frequency; in said grid-connected passive mode, said inverter automatically detects a port voltage data characteristic of the external power grid, and adapts phase and frequency to operation, and avoids islanding, for passively outputting said inverted power according to the detected port voltage data characteristic.

18. The device, as recited in claim 16, wherein said inverter has a max power point track (MPPT in short) function; said inverter has an off-grid active mode and a grid-connected passive mode; in said off-grid active mode, said inverter shields port data detection and outputs said inverted power with preset voltage and frequency; in said grid-connected passive mode, said inverter automatically detects a port voltage data characteristic of the external power grid, and adapts phase and frequency to operation, and avoids islanding, for passively outputting said inverted power according to the detected port voltage data characteristic.

19. The device, as recited in claim 17, wherein said system operation mode controller comprises:
a box (cabinet) panel mode controller;
a portable mode selector; and
a remote two-way communication control port;
wherein said box (cabinet) panel mode controller, said portable mode selector, and said remote two-way communication control port are respectively connected to and controls said logical control unit; said box (cabinet) panel mode controller, said portable mode selector, said remote two-way communication control port, and said logical control unit all utilize digital logic chips and micro control units (MCU for short).

20. The device, as recited in claim 18, wherein said system operation mode controller comprises:
a box (cabinet) panel mode controller;
a portable mode selector; and
a remote two-way communication control port;
wherein said box (cabinet) panel mode controller, said portable mode selector, and said remote two-way communication control port are respectively connected to and controls said logical control unit; said box (cabinet) panel mode controller, said portable mode selector, said remote two-way communication control port, and said logical control unit all utilize digital logic chips and micro control units (MCU for short).

21. The device, as recited in claim 19, wherein said storage battery charging controller has an alternating input; an isolation mechanism is provided at an output terminal of said storage battery charging controller for preventing an inverse current from said storage battery.

22. The device, as recited in claim 20, wherein said storage battery charging controller has an alternating input; an isolation mechanism is provided at an output terminal of said storage battery charging controller for preventing an inverse current from said storage battery.

23. A control method of an off-grid/grid-connected integrated solar power generation system, comprising steps of:
selecting an off-grid mode or a grid-connected mode by a system operation mode controller, and controlling work states of an electrical input orientation driver, a generation and storage driver, and an electrical output orientation driver by a logical control unit according to feedback about electrical power loads of a solar panel, an inverter, a storage battery charging controller, and a storage battery matrix, in such a manner that the off-grid/grid-connected integrated solar power generation system circularly repeats charging, storing, generating and outputting of solar electrical power in the off-grid mode or the grid-connected mode.

24. The method, as recited in claim 23, wherein in the off-grid mode, the storage battery matrix is charged only when solar electrical power is enough for supplying users; in the off-grid mode, charging, storing, generating and outputting of the solar electrical power is circulated as follows: after the off-grid mode is selected by the system operation mode controller, the logical control unit operates the inverter in an off-grid active mode, and connects the electrical output orientation driver to the inverter; in the meantime, the logical control unit controls the electrical output orientation driver to provide off-grid output drive; when an output voltage of the solar panel meets requirements of charging, storing, generating and outputting, which means the solar electrical power outputted is well enough, under control of the logical control unit, the electrical input orientation driver is connected to an output terminal of the solar panel, a generation driver is connected to the electrical output orientation driver, and a storage driver is disconnected from the storage battery charging controller, in such a manner that a solar power generation circuit is switched on, so as to provide off-grid solar power generation; when the output voltage of the solar panel fails to meet the requirements of charging, storing, generating and outputting, which means the solar electrical power is not enough, under the control of the logical control unit, the electrical input orientation driver is disconnected from the solar panel and connected to a discharge terminal of the storage battery matrix for switching on a solar electrical power storage and generation circuit, in such a manner to provide an off-grid storage battery matrix output; when the logical control unit detects that the solar electrical power outputted satisfies requirements of the users, the logical control unit controls the generation and storage driver to communicate with the storage battery charging controller for switching on a solar electrical power storage circuit, in such a manner to store extra solar electrical power into the storage battery matrix by the storage battery charging controller and provide storage operation of the solar electrical power.

25. The method, as recited in claim 23, wherein in the grid-connected mode, the solar electrical power is for direct grid-connected generation only when the storage battery matrix is fully loaded or a sample current of storage batteries is zero, at the moment, the storage battery is in a default emergency state; in the grid-connected mode, circulation of charging, storing, generating and outputting of the solar electrical power is: after the grid-connected mode is selected by the system operation mode controller, the logical control unit operates the inverter in a grid-connected passive mode, the inverter automatically detects a port voltage data characteristic of an external power grid, and adapts phase as well as frequency to operation, avoids islanding, etc., for passively outputting according to the port voltage data characteristic; in the grid-connected mode, when the output voltage of the solar panel meets requirements of charging, storing, generating and outputting, which means the solar electrical power outputted is well enough, under control of the logical control unit, the electrical input orientation driver is connected to the solar panel, the storage driver is connected to the storage battery charging controller, the electrical input orientation driver is disconnected from the discharge terminal of the storage battery, and the electrical output orientation driver is disconnected from the external power grid for switching on the solar electrical power storage circuit, in such a manner to store the solar electrical power in the storage battery matrix; when the storage battery matrix is fully loaded, the logical control unit controls the storage driver to be disconnected from the storage battery charging controller and controls the generation driver to be connected to a grid-connected output driver for switching on the solar power generation circuit, in such a manner to provide direct grid-connected solar power generation; when the output voltage of the solar panel doesn't meet the requirements of charging, storing, generating and outputting, which means the solar electrical power is not enough, under control of the logical control unit, the electrical input orientation driver is disconnected from the solar panel and connected to the discharge terminal of the storage battery matrix, and the logical control unit controls the storage driver to be disconnected from the storage battery charging controller and controls the electrical output orientation driver to be connected to a grid-connected port for switching on the solar electrical power storage and generation circuit, in such a manner to provide grid-connected solar power generation by the storage battery matrix; when the logical control unit detects a requirement of storing power from the external power grid in the storage battery, the logical control unit controls the electrical output orientation driver to provide grid-connected output drive, the generation driver is disconnected from the inverter, and the output terminal of the storage battery matrix is disconnected from the electrical input orientation driver, at the meantime, the logical control unit controls the storage driver to be connected to the storage battery charging controller for switching on an inverse input storage circuit of the storage battery for storing the power from the external power grid, in such a manner to charge the storage battery matrix with the power of the external power grid.

26. The method, as recited in claim 24, wherein in the grid-connected mode, the solar electrical power is for direct grid-connected generation only when the storage battery matrix is fully loaded or a sample current of storage batteries is zero, at the moment, the storage battery is in a default emergency state; in the grid-connected mode, circulation of charging, storing, generating and outputting of the solar electrical power is: after the grid-connected mode is selected by the system operation mode controller, the logical control unit operates the inverter in a grid-connected passive mode, the inverter automatically detects a port voltage data characteristic of an external power grid, and adapts phase as well as frequency to operation, avoids islanding, etc., for passively outputting according to the port voltage data characteristic; in the grid-connected mode, when the output voltage of the solar panel meets requirements of charging, storing, generating and outputting, which means the solar electrical power outputted is well enough, under control of the logical control unit, the electrical input orientation driver is connected to the solar panel, the storage driver is connected to the storage battery charging controller, the electrical input orientation driver is disconnected from the discharge terminal of the storage battery, and the electrical output orientation driver is disconnected from the external power grid for switching on the solar electrical power storage circuit, in such a manner to store the solar electrical power in the storage battery matrix; when the storage battery matrix is fully loaded, the logical control unit controls the storage driver to be disconnected from the storage battery charging controller and controls the generation driver to be connected to a grid-connected output driver for switching on the solar power generation circuit, in such a manner to provide direct grid-connected solar power generation; when the output voltage of the solar panel doesn't meet the requirements of charging, storing, generating and outputting, which means the solar electrical power is not enough, under control of the logical control unit, the electrical input orientation driver is disconnected from the solar panel and connected to the discharge terminal of the storage battery matrix, and the logical control unit controls the storage driver to be disconnected from the storage battery charging controller and controls the electrical output orientation driver to be connected to a grid-connected port for switching on the solar electrical power storage and generation circuit, in such a manner to provide grid-connected solar power generation by the storage battery matrix; when the logical control unit detects a requirement of storing power from the external power grid in the storage battery, the logical control unit controls the electrical output orientation driver to provide grid-connected output drive, the generation driver is disconnected from the inverter, and the output terminal of the storage battery matrix is disconnected from the electrical input orientation driver, at the meantime, the logical control unit controls the storage driver to be connected to the storage battery charging controller for switching on an inverse input storage circuit of the storage battery for storing the power from the external power grid, in such a manner to charge the storage battery matrix with the power of the external power grid.
